(19) United States
(12) Patent Application Publication
(10) Pub. No.: US 2014/0225796 A1
(43) Pub. Date: Aug. 14, 2014

(54) ULTRA-BROADBAND OFFSET CASSEGRAIN DICHROIC ANTENNA SYSTEM FOR BIDIRECTIONAL SATELLITE SIGNAL COMMUNICATION

(71) Applicants: Chien-An Chen, Foster City, CA (US); Linda Chen, Foster City, CA (US)

(72) Inventors: Chien-An Chen, Foster City, CA (US); Linda Chen, Foster City, CA (US)

(21) Appl. No.: 13/762,402

(22) Filed: Feb. 8, 2013

(51) Int. Cl. H01Q 15/00

(52) U.S. Cl. CPC H01Q 15/0033
USPC 343/781 CA

(57) ABSTRACT

An ultra-wide bandwidth multi-channel offset Cassegrain dichroic antenna system serves for bidirectional signal transmission between a ground-based system and at least one satellite. By properly selecting the high and low frequency band, ultra wide bandwidths for both high and low frequency band signals are provided. The band widths are about 15%, even up-to 50%, of the carrier frequency. Especially, the band widths for high frequency band signals are much wider than that for low frequency band signals. The low frequency band can be from 10.7 up-to 12.75 GHz while the high frequency band can be from 17 up-to 30 GHz. Furthermore, in order to achieve ultra-wide bandwidth, a surface of a dichroic sub-dish is divided into a plurality of unit areas. Arrangements of the metal dichroic element of one unit area are slightly different from another unit area f, while the metal elements on same unit area are identical.

### FIELD OF THE INVENTION

The present invention relates to an antenna system, and in particular to an extreme broadband offset Cassegrain dichroic antenna system for bidirectional satellite signal transmissions.

### BACKGROUND

The following patents and documents are related to the present invention, including

U.S. Pat. No. 6,774,861 (Reference 1),

U.S. Pat. No. 6,512,485B2 (Reference 2),

V. Agrawal, W. Imbriale “Design of a dichroic cassegrain subreflector” IEEE Trans. on Antenna & Propagation, 1979 Vol. 27, Issue 4, Page 466˜473 (Reference 3), and

U.S. Pat. No. 3,231,892 (Reference 4)

In the conventional Dichroic Sub-dish antennas, including Offset Cassegrain Antenna and non-offset Cassegrain Reflector, the dichroic sub-dish is formed by arrangement of a plurality of uniform and periodic dichroic elements. Namely, all the elements in the dichroic sub-dish 14 have the same specification and are arranged uniformly and periodically.

Reference 2 discloses a frequency selective surface (FSS), or a dichroic dish (which reflects incident waves or transmits incident waves). Generally, a dichroic dish is used as a dichroic sub-dish (or be called as a sub-reflection surface) for dividing waves of two different frequency bands, in that, waves of one frequency band transmits through the dichroic sub-dish and then are focused to a prime focus point; and waves of another frequency band reflects from the dichroic sub-dish to be focused to an image focus point. This kind of conventional multi-frequency band antenna is disclosed in References 3 and 4. Generally, FSS or Dichroic technology is used for large capacity military or dedicated satellite communications with some special purpose applications. They are almost not used in low cost ground antenna of commercial satellite communication for signal transmission and receiving.

In conventional FSS or dichroic technology, the high frequency feed horn is placed in the image focus point and the low frequency feed horn is placed in the prime feed horn. Bandwidths of the high frequency band and low frequency band are narrow. Generally, the bandwidth for signal communication is 5% to 10% of the carrier frequency. In above mentioned Reference 2, two high frequency bands are used, one for carrier frequency of 20 GHz, and another for 30 GHz; and only one low frequency band is used for carrier frequency of 12.4 GHz. The bandwidth of each band is about 5% to 10% of the carrier frequency.

In conventional antenna design, the carrier frequency ratio for high frequency band to low frequency band is greater than 1.5. As illustrated in the Reference 3, the carrier frequency ratio for high frequency band to low frequency band is very large. The carrier frequency for high frequency band is 12 GHz and that for low frequency band is 6 GHz. Therefore, the carrier frequency ratio for high frequency band to low frequency band is 2. Moreover, a Cassegrain reflector without any offset is used. The offset Cassegrain reflector is used in recent DBS (satellite TV broadcasting). As illustrated in References 1 and 2, the carrier frequency ratio of high frequency band to low frequency band is between 1.5 to 2.0, for example, 30 GHz/12 GHz and 20 GHz/12 GHz. However, for an offset dichroic sub-dish, due to the design of offset, the electromagnetic wave incident into the surface of the dichroic sub-dish is not vertical to the sub-dish surface. The incident angles are varied through a wide range. As a result, it is difficult to resolve this problem and bandwidths of conventional dichroic antenna are not wide.

In current applications, especially for next generation DBS (satellite TV broadcasting) and two-way satellite data communication (VSAT type), conventional satellite communication systems can not satisfy the huge data bandwidth requirements for the rapidly growing multi-media market, such as HDTV, 3D HDTV, IPTV (Voice on demand, VOD), bi-directional communication Internet, etc. For future satellite communication, one satellite must provide the capability using two Ku bands and one Ka band as signal downloading bands, and meanwhile, one Ku band and one Ka band as signal uplinking bands. As a result overall communication bandwidths must be sufficiently large. Furthermore, in current requirement for the next generation satellite TV broadcasting and two-way satellite data communication, the bandwidths for high frequency band are much greater than that for low frequency band. For example; the high frequency band may be from 17 GHz up to 30 GHz while the low frequency band may be from 10.7 up to 12.75 GHz.

Referring to References 1 and 2, in conventional dichroic Cassegrain antenna, a high frequency feed horn is placed at image focus point of a dichroic sub-dish. The high frequency electromagnetic wave radiates from or receives by the high frequency feed horn will generate electromagnetic oscillation of the metal element (dichroic element) on the dichroic sub-dish sheet such that the high frequency electromagnetic wave will be reflected by the dichroic sub-dish. The bandwidth of such structure is not wide. Very complicate multi-layer dichroic surfaces usually are tried to broad the bandwidth. When incident angles of electromagnetic waves incident to the multi-layer dichroic surfaces are varied through a large range as in the offset cassegrain reflector configuration, it is difficult or impossible for the multi-layer dichroic surfaces design to achieve a wide bandwidth Therefore, conventional dichroic antenna cannot match the wide bandwidth requirement of next generation satellite TV broadcasting and two-way satellite data communication.

### SUMMARY OF THE INVENTION

Therefore the object of the present invention is to resolve the problems of above mentioned prior arts. The present invention provides an ultra-wide bandwidth offset Cassegrain dichroic antenna system. In this embodiment, ultra wide bandwidths for both high and low frequency bands are provided. The band widths are about 15%, even up to 50%, of the carrier frequency. Especially, the band width for high frequency band is much wider than that for low frequency band. For next generation satellite TV broadcasting (DBS) and two-way satellite data communication, the band width of low frequency band for data down-link is set from 10.7 GHz to 12.75 GHz, and the band width of high frequency bands are set at 17 GHz for data up-link, 18 to 20 GHz for data down-link, 24 to 26 GHz for data up-link (reverse band) and also 28 to 30 GHz for data up-link. The overall bandwidth for high frequency data transmission is from 17 to 30 GHz. The bandwidth to carrier frequency is more than 50%. The present invention provides a structure which satisfies above mentioned confinements.

In the present invention, the offset dichroic sub-dish configuration is used to reduce the blockage effect from the sub-dish. Two brand new concepts and breakthroughs for the dichroic design and offset dichroic Cassegrain reflector design are presented. Firstly, in the present invention, the high frequency band is much wider than that for low frequency band. Thus, in the present invention, the metal element (dichroic element) on the dichroic sub-dish sheet is designed to generate electromagnetically resonant oscillation with respect to the incident low frequency band electromagnetic waves such that the low frequency band electromagnetic wave is reflected and focused at the image focus point of the dichroic sub-dish. The high frequency electromagnetic waves will transmit through the dichroic sub-dish to the prime focus point of the main offset reflector. Furthermore, it should be noted that in the present invention, the metal elements in the dichroic sub-dishs are not uniformly and periodic distributed. The arrangement of the metal elements in the dichroic sub-dish is slightly changed based on the incident angles of the incident electromagnetic waves. A single layer dichroic surface is designed to correct the effect of different electromagnetic incident angle such that it is not sensitive to incident electromagnetic waves from different incident angles. Therefore, in the present invention, the surface of a dichroic sub-dish is divided into a plurality of different areas. The arrangement of the metal elements in one area is different from another one, while the metal elements in a same area are identical. As a result, the dichroic sub-dish can receive incident electromagnetic waves from different angles with preferred electromagnetic wave reflectivity for low frequency signals and preferred electromagnetic wave transmittance for high frequency signals and the bandwidths thereof are wide.

### BRIEF DESCRIPTION OF THE DRAWINGS

FIG. 1 shows the first embodiment of the present invention.

FIGS. 2A, 2B and 2C show the dichroic sub-dishes of the prior arts.

FIG. 2D is a front view showing the structure of the metal elements in the dichroic sub-dish of the present invention.

FIG. 2E is a perspective view showing the structure of the metal elements in the dichroic sub-dish of the present invention.

FIGS. 3A and 3B show a first example of typical dichroic performance about the determination of the return lose for normal incident electromagnetic waves.

FIGS. 4A and 4B show a second example of typical dichroic performance about the determination of the return lose for different incident electromagnetic waves with TE polarization.

FIGS. 5A and 5B show a third example of typical dichroic performance about the determination of the return lose for different incident electromagnetic waves with TM polarization.

FIG. 6 is a schematic view showing the variation of the included angles between incident electromagnetic waves and a surface of the dichroic sub-dish.

FIG. 7 shows the embodiment of multiple prime feed horns and multiple image feed horns for multi-satellites data communication

### DETAILED DESCRIPTION OF THE PREFERRED EMBODIMENTS

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

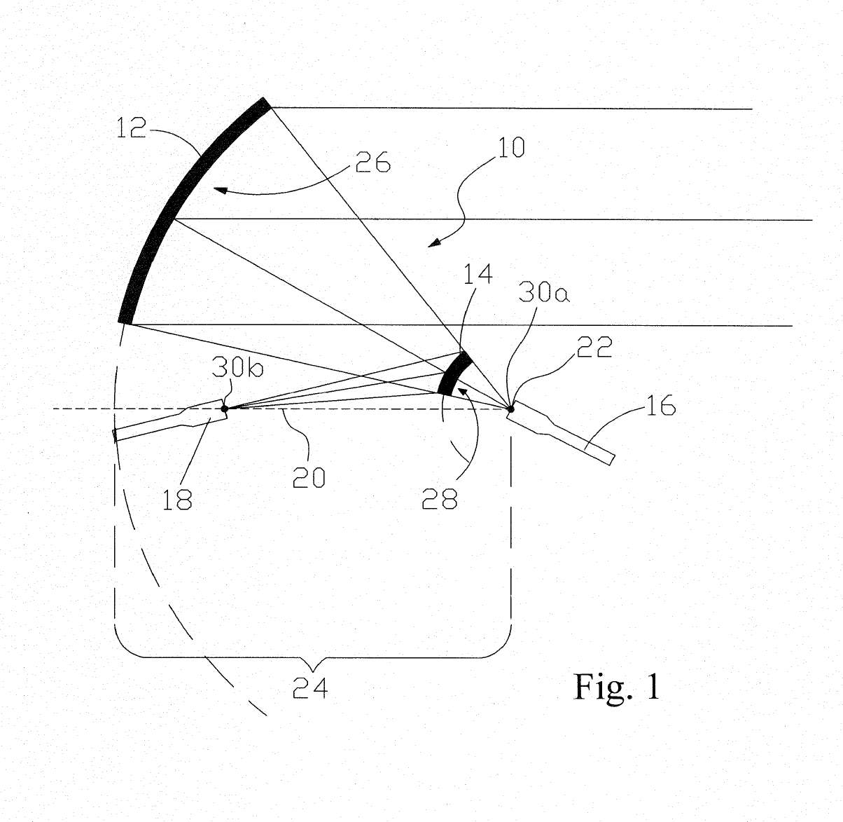

With reference to FIG. 1, the arrangement about the structural elements of the present invention is illustrated. The definitions of the elements in structure of the present invention described in the following may refer to U.S. Pat. Nos. 6,774,861 and 6,512,485B2. The structure of the present invention will be described herein.

An antenna system 10 serves for receiving signals from or transmitting signals to a satellite. Thus, the signals uplinking or downlinking between a ground based system and a satellite can be performed by the antenna system 10. The antenna system 10 mainly includes the following elements.

A paraboloidal reflector 12 has a focal axis 20 and a focus point 22 in the focal axis 20. A focal length 24 is defined as a distance between the focus 22 and an apex of the paraboloidal reflector 12. The paraboloidal reflector 12 has a radiation aperture 26 defined as a cross section capable of receiving external radiation. In the present invention, the paraboloidal reflector 12 is arranged to be offset from the focal axis 20.

A dichroic sub-dish 14 is a lens arranged along a hyperbolidal surface 14′, as illustrated in FIG. 1 and also referring to U.S. Pat. Nos. 6,774,861 and 6,512,485B2. In practical usage, the dichroic sub-dish 14 may be a plane lens. The dichroic sub-dish 14 has a radiation aperture 28. The hyperbolidal surface arranging the dichroic sub-dish 14 has a prime focus point 30a and an image focus point 30b. The prime focus point 30a is in coincident with the focus 22 of the paraboloidal reflector 12. In the present invention, the prime focus point 30a and the image focus point 30b are in the focal axis of the hyperbolidal surface 14′. The focal axis 20 of the hyperbolidal surface 14′ can be in coincident with or non-coincident with the focal axis 20 of the paraboloidal reflector 12. The image focus point 30b and the prime focus point 30a are at two opposite sides of the dichroic sub-dish. In the present invention, the dichroic sub-dish 14 is offset from the focal axis of the hyperbolidal surface arranging the dichroic sub-dish 14. An axis of the dichroic sub-dish 14 may be coincident or non-coincident with the axis of the paraboloidal reflector 12.

In the present invention, the dichroic sub-dish 14 serves to reflect low frequency band signals and pass through high frequency band signals. In the present invention, the low frequency band is a band with frequencies between 9 GHz and 15 GHz, and the high frequency band is a band with frequencies between 17 GHz to 30 GHz. The bands used in the present invention is much higher than those used in above mentioned prior art. Thus, the so called low frequency band of the present invention may include or hight than the high frequency bands of the prior arts as cited in above prior art.

A prime feed horn 16 is a conventional horn shape or other shape electromagnetic wave transmitting and/or receiving unit. The phase center of the prime feed horn 16 is coincident with the prime focus point 30a for transmitting high frequency electromagnetic wave to the dichroic sub-dish 14 or receiving high frequency electromagnetic wave transmitting through the dichroic sub-dish 14.

An image feed horn 18 is a conventional horn shape or other shape electromagnetic wave receiving and/or transmitting unit. The phase center of the image feed horn 18 is coincident with the image focus point 30b for receiving low frequency electromagnetic wave reflected from the dichroic sub-dish 14 or transmitting low frequency electromagnetic wave to the dichroic sub-dish 14.

In the present invention, the prime feed horn 16 and the image feed horn 18 may have the conventional horn shape or other shapes.

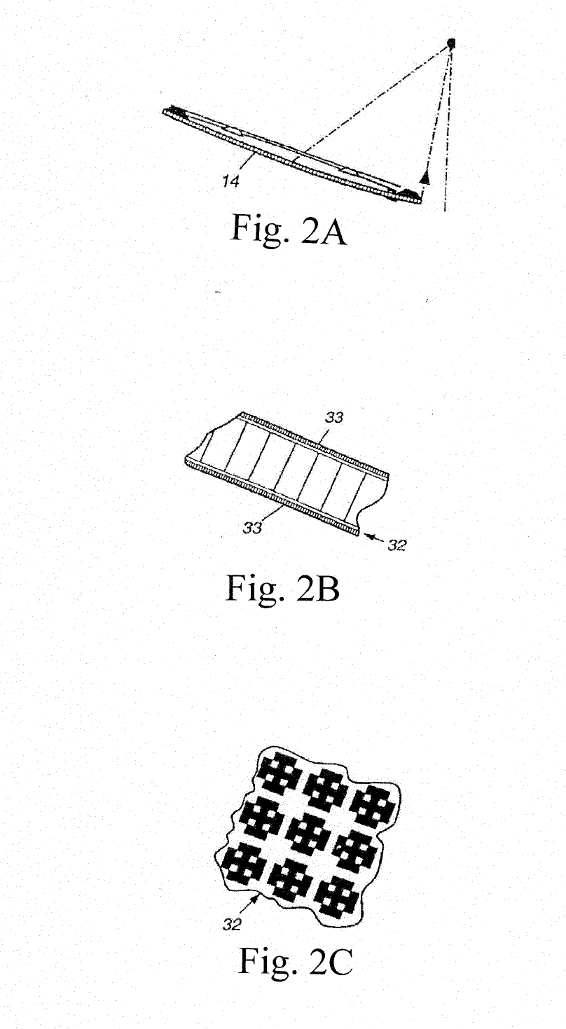

The selection of material for forming the dichroic sub-dish 14 may refer to paragraphs 4 and 5 in U.S. Pat. No. 6,774,861. With reference to FIGS. 2A, 2B and 2C, in that, the dichroic sub-dish 14 can be formed. It must be noted that FIGS. 2A, 2B and 2C are for reference only and are not limited to the only way of dichroic geometry/material configuration, other suitable ways are permissible in the present invention. FIGS. 2D and 2E show the idea of slightly change dichroic element design by area to correct the electromagnetic wave incident angle effects.

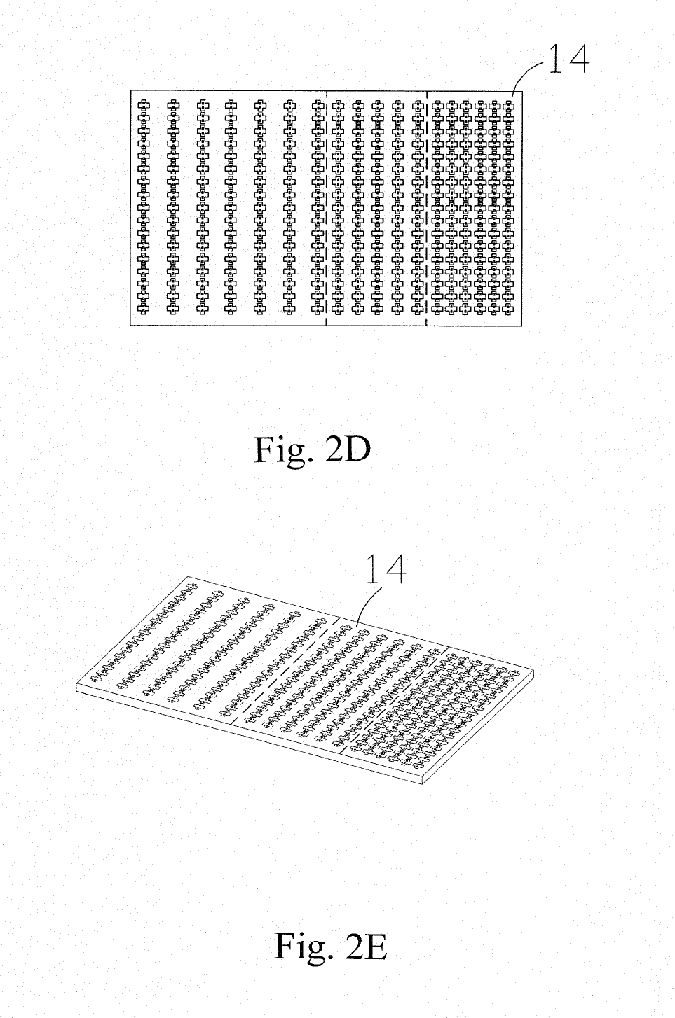

With reference to FIGS. 3A and 3B, in this embodiment, the dichroic sub-dish 14 is formed by a plurality of metal elements 50 which are arranged as a plurality of parallel longitudinal rows; and further, electromagnetic waves 55 are incident into a dichroic sub-dish 14 vertically (normal incidence). The polarization of incident electromagnetic waves are varied In FIG. 3A, a direction of each arrow represents the polarized vector of the incident electromagnetic waves with respect to a predetermined arranging vector of the metal elements on the incident surface of the dichroic sub-dish. The angles indicated at distal ends of the arrows represent the included angles between the polarized vector and the orientations of the arrangements of the metal elements in the dichroic sub-dish. From FIG. 3, it is illustrated that these angles are varied from 0 to 90 degrees. FIG. 3B shows the return lose of the incident electromagnetic wave reflected from the surface of the dichroic sub-dish in a specific included angle. In this embodiment, the included angles are 15, 30, 45, 60, 75, 90 degrees as indicated at a lower left side of FIG. 3B.

With reference to FIG. 3B, it is illustrated that when the incident angle is 90 degrees (normal incidence), the return lose from 9 GHz to 15 GHz is very low. Namely, at this band, most of the incident electromagnetic waves are reflected from the surface of the dichroic sub-dish 14 with very low lose, while when the frequency range is between 17 GHz to 30 GHz, the return lose is high. Thus, at this band, most of incident waves will transmit through the dichroic sub-dish 14 without reflection. Therefore, from above discussion, it is known that in this structure, when the frequency of incident electromagnetic wave is between 9 GHz to 15 GHz (low frequency), it has a preferred reflectivity with respect to the dichroic sub-dish 14 so as to be received by the image feed horn 18, while when the frequency of the incident electromagnetic wave is between 17 GHz to 30 GHz (high frequency), it has a preferred transmittance with respect to the dichroic sub-dish 14 so that the electromagnetic wave is received by the prime feed horn 16. As shown in FIG. 3B, it is illustrated that variations of polarization angles only make very slight effect to the return lose.

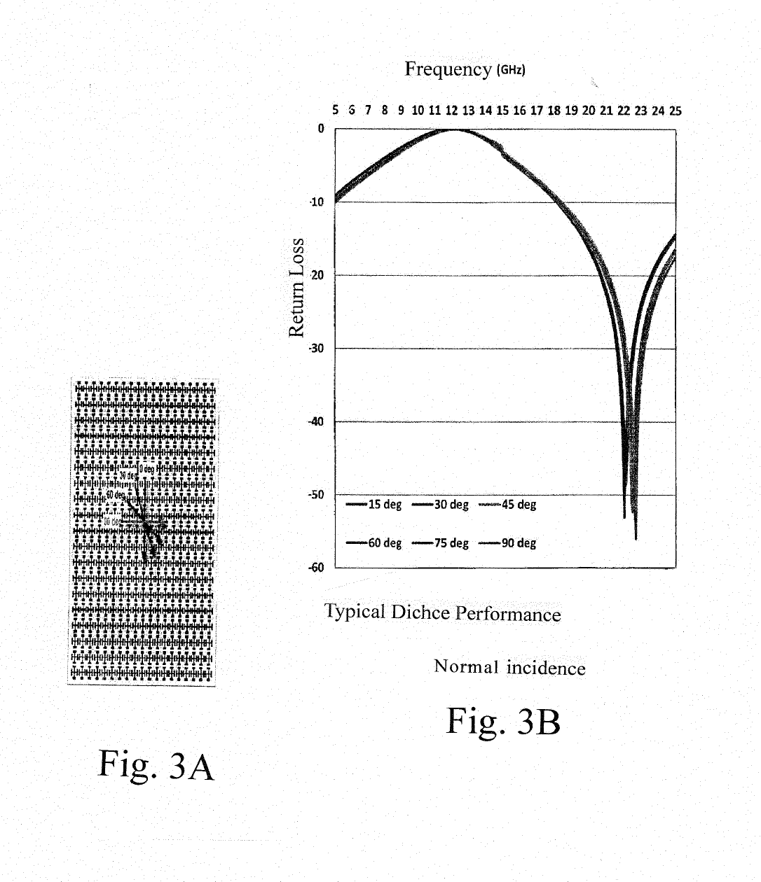

Referring to FIGS. 4A and 4B, it is illustrated that the electromagnetic wave incident to the dichroic sub-dish 14 is horizontal polarized with respect to the plane of the dichroic sub-dish 14 which is called TE incidence. The incident angles are 0.1°, 30°, 45°, 60° and 80°. FIG. 4B shows the return lose with respect to the above incident angle. From FIG. 4B, it is shown that in high frequencies, the return lose is varied with respect to the incident angle. Therefore, it needs to consider this effect in design of the dichroic sub-dish 14. The arrangement of the metal elements must be designed based on this effect so that that the return loses in different angles approach to the result as the incident angle is 90 degrees (normal incidence), which provides a better effect. It is also noted that in FIG. 4B when the variation of incident is less than 30 degree, the effect is small. In present invention, the arrangement of dichroic elements is designed as shown in FIG. 2D, where different unit area is designed for different incident angle.

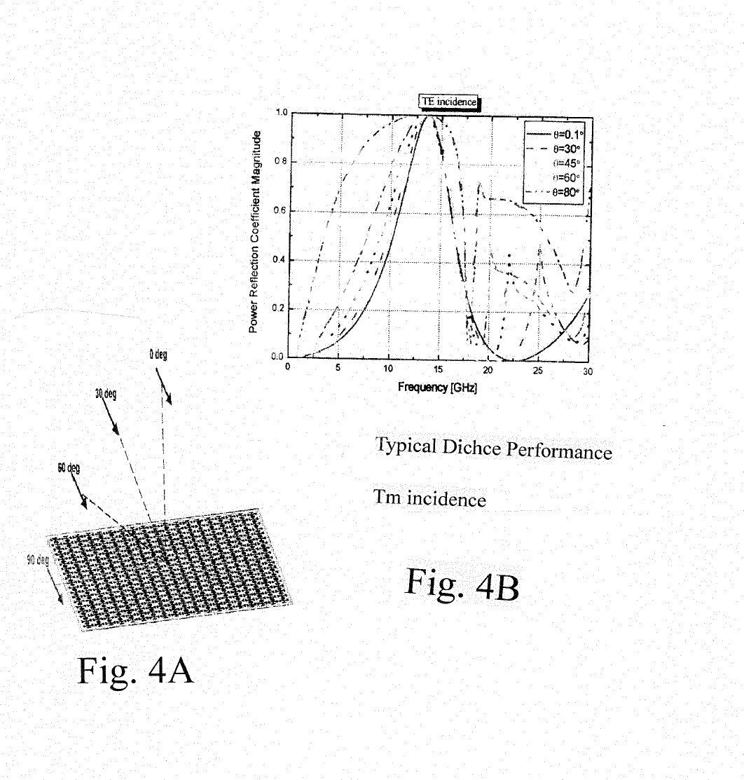

With reference to FIGS. 5A and 5B, in that experiments, the electromagnetic wave is vertical polarization (TM incidence) electromagnetic waves which radiate into the dichroic sub-dish 14 with different incident angles, which are 0.1°, 30°, 45°, 60° and 80°. It is illustrated that the return loses for high frequency band is very good with respect to the different incident angle while for low frequency band, it is varied through a wide range which is not beneficial. Therefore, it needs to consider this effect in design of the dichroic sub-dish 14. The arrangement of the metal sheet must be designed based on this effect so that that the return loses in different angles approach to the result as the incident angle is 90 degrees (normal incidence), which provides a better effect. The result is are shown in FIG. 2D.

As comparing with above mentioned prior art, in the prior art, low frequency band is between 5 GHz to 7 GHz and high frequency band is between 9 GHz to 12 GHz, and the operating frequency for the dichroic usually is designed for 5 to 10% of the frequency band while in the present invention, low frequency band is between 9 GHz to 15 GHz and the high frequency band is between 17 GHz to 30 GHz. It is known that the bandwidths of the present invention are very wider than those in the prior art. The present invention is operated in a very high frequency and thus the bandwidth is expanded to be more than 50% of the carrier frequency, which is better than the 5% to 10% of the prior art result. The technology of the present invention can broaden the bandwidth in communication. As a result, the amount of the data band-width for communication is greatly increased. Therefore, the present invention is greatly promoted from the prior arts.

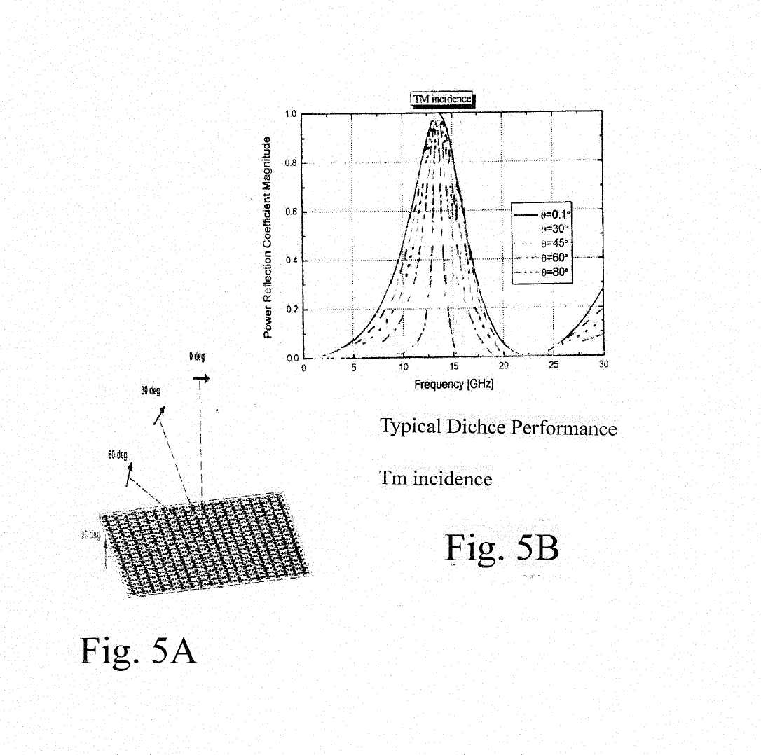

With reference to FIG. 6, the incident angles at two extreme ends of the dichroic sub-dish 14 between the transmitting path of the electromagnetic waves emitted from or received by the prime feed horn 16 and a cross section of a surface of the dichroic sub-dish 14 are θ1 and θ2 which are varied through a very wide range. Similarly, the incident angles at two extreme ends of the dichroic sub-dish 14 between the transmitting path of the electromagnetic waves emitted from or received by the image feed horn 18 and a cross section of a surface of the dichroic sub-dish 14 are θ3 and θ4 which are varied through a very wide range. Thus, the physical reactions of the material in the dichroic sub-dish 14 are different from one area to another area. Therefore, based on the experimental results shown in FIGS. 3A, 3B, 4A, 4B, 5A and 5B, in the present invention, the arrangement of the metal dichroic elements in the dichroic sub-dish 14 are changed based on the angle of the electromagnetic waves incident into the dichroic sub-dish 14, as illustrated in FIGS. 2D and 2E. Preferably, the metal dichroic elements in the dichroic sub-dish 14 are divided into a plurality of areas. The arrangement of the metal dichroic elements of one area is different from those of another one, while the metal dichroic elements in a same area are identical, namely they are uniform and periodic in the same area. The arrangements of the metal dichroic elements in different area of the dichroic sub-dish are slightly changed based on the incident angles of the incident electromagnetic waves. As a result, the dichroic sub-dish can receive incident electromagnetic waves from different angles with preferred electromagnetic wave reflectivity for low frequency signals and preferred electromagnetic wave transmittance for high frequency signals and the bandwidths thereof are wide. Based on the results shown in FIGS. 4 and 5, it is shown that the physical reactions of the metal dichroic elements with respect to the incident angles of the electromagnetic waves are not sensitive as the variation of incident angles is within 30 degrees. Therefore, the surface of the dichroic sub-dish 14 is divided into different areas which cover a range in that the variation of incident angles is within 30 degrees, preferably within 20 degrees.

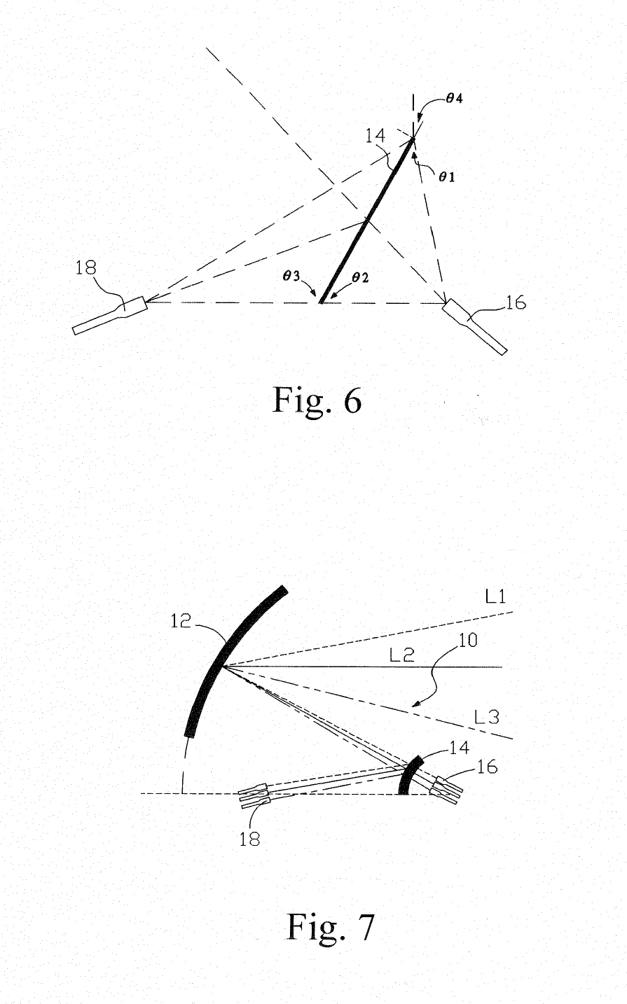

With reference to FIG. 7, in case of multi-satellites data communication there are several transmission paths L1, L2 and L3 for a plurality of satellite signals from different satellite, while the arrangement of the paraboloidal reflector 12 and dichroic sub-dish 14 is identical to that illustrated in FIG. 6, a plurality of prime feed horns and a plurality of image feed horns are arranged from receiving signals from different paths.

Advantages of the present invention are that: the selection of the low frequency band and high frequency band cause that the two bands are ultra-broadband. Generally, the bandwidth to carrier frequency is about 15%, even about 50%. The bandwidth of the high frequency band is wider than that of the low frequency band. For next generation satellite TV broadcasting (DBS) and two-way satellite data communication, the band width of low frequency signals for data down-link is set from 10.7 GHz to 12.75 GHz, and the band width of high frequency signals is set at 17 GHz for data up-link, 18 to 20 GHz for data down-link, 24 to 26 GHz for data up-link and 28.5 to 30 GHz for data up-link. The bandwidth to carrier frequency is more than 50%. The present invention provides a structure which satisfies above mentioned confinements. In the present invention, the offset dichroic sub-dish can reduce the blockage effect from the sub-dish so as to provide a brand new concept which is different from conventional dichroic and Cassegrain reflector. Furthermore, the metal dichroic elements in the dichroic sub-dishs are divided into a plurality of areas. The arrangement of the metal dichroic elements of one area is different from another one, while the metal dichroic elements in a same area are identical. The arrangements of the metal dichroic elements in the dichroic sub-dish are not uniform and not periodic. The arrangement of the metal dichroic elements in the dichroic sub-dish is slightly changed based on the incident angles of the incident electromagnetic waves. As a result, the dichroic sub-dish can receive incident electromagnetic waves from different angles with preferred electromagnetic wave reflectivity for low frequency signals and preferred electromagnetic wave transmittance for high frequency signals and the bandwidths thereof are wide.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An ultra-broadband offset Cassegrain dichroic antenna system for transmitting signals to and receiving signals from a satellite including transmitting signals to and receiving signals from a satellite; the antenna system serving for signal down-linking or up-linking between a ground device and the satellite; the antenna system comprising:
a paraboloidal reflector having a focal axis and a focus at the focal axis; the paraboloidal reflector being arranged to be offset from the focal axis;
a dichroic sub-dish being a lens arranged along a hyperbolidal surface; the hyperbolidal surface arranging the dichroic sub-dish having a prime focus point and an image focus point; the prime focus point being coincident with the focus of the paraboloidal reflector; the prime focus point and the image focus point being in the focal axis of the hyperbolidal surface; the focal axis of the hyperbolidal surface being coincident with or non-coincident with the focal axis of the paraboloidal reflector; the image focus point and the prime focus point being at two opposite sides of the dichroic sub-dish; the dichroic sub-dish reflecting low frequency signals and passing through high frequency signals;
a prime feed being an electromagnetic wave transmitting and receiving unit; the phase center of the prime feed being coincident with the prime focus point for receiving high frequency electromagnetic wave transmitting through the dichroic sub-dish or transmitting high frequency electromagnetic wave to the dichroic sub-dish;
an image feed being an electromagnetic wave transmitting and receiving unit; the phase center of image feed being coincident with the image focus point for receiving low frequency electromagnetic wave reflected from the dichroic sub-dish or transmitting low frequency electromagnetic wave to the dichroic sub-dish;
wherein the dichroic sub-dish reflects low frequency signals to be received by the image feed; and high frequency signals passing through the dichroic sub-dish to be received by the prime feed.

2. The ultra-broadband offset Cassegrain dichroic antenna system for transmitting signals to and receiving signals from a satellite as claimed in claim 1, wherein the low frequency band is ranged from 9 GHz to 15 GHz and the high frequency band is ranged from 17 GHz to 30 GHz.

3. The ultra-broadband offset Cassegrain dichroic antenna system for transmitting signals to and receiving signals from a satellite as claimed in claim 1, wherein the prime feed and the image feed are horn shape or other shape electromagnetic wave receiving and transmitting devices.

4. The ultra-broadband offset Cassegrain dichroic antenna system for transmitting signals to and receiving signals from a satellite as claimed in claim 1, wherein a surface of the dichroic sub-dish is divided into a plurality of unit areas; the arrangement of the metal dichroic elements of one unit area is different from another one unit, while metal dichroic elements on a same unit area are identical, that is, they are uniform and periodic; the arrangements of the metal dichroic elements on different unit area of the dichroic sub-dish are slightly changed based on the incident angles of the incident electromagnetic waves with respect to the dichroic surface.

5. The ultra-broadband offset Cassegrain dichroic antenna system for transmitting signals to and receiving signals from a satellite as claimed in claim 1, wherein there are multi-satellites and there are a plurality of side-by-side prime feeds (feed cluster); the plurality of side-by-side prime feeds serves for receiving high frequency signals which are from multi-satellites and reflected by main paraboloidal reflector and then passed through the dichroic sub-dish or emitting high frequency signals to and passing the dichroic sub-dish.

6. The ultra-broadband offset Cassegrain dichroic antenna system for transmitting signals to and receiving signals from a satellite as claimed in claim 1, wherein a satellite being multi-satellites and said there are a plurality of side-by-side image feeds (image feed cluster); the plurality of side-by-side image feeds serves for receiving low frequency signals which are from multi-satellites and reflected from main paraboloidal reflector and then reflected from the dichroic sub-dish or emitting low frequency signals to and reflecting by the dichroic sub-dish.

7. The ultra-broadband offset Cassegrain dichroic antenna system for transmitting signals to and receiving signals from a satellite as claimed in anyone of claim 1, wherein the surface of the dichroic sub-dish is divided into different unit areas; each unit area covers a range in that the variation of incident angles from a selected one of the feed cluster to a surface of the dichroic sub-dish is within 10 to 30 degrees.
